(19) United States
(12) Patent Application Publication
(10) Pub. No.: US 2025/0166111 A1
(43) Pub. Date: May 22, 2025

(54) ACTIVE-DEFENSE DETECTION METHOD BASED ON FACIAL LANDMARK WATERMARKING

(71) Applicants: Qilu University of Technology (Shandong Academy of Sciences), Jinan (CN); Shandong Artificial Intelligence Institute, Jinan (CN); SHANDONG COMPUTER SCIENCE CENTER (NATIONAL SUPERCOMPUTING CENTER IN JINAN), Jinan (CN)

(72) Inventors: Minglei SHU, Jinan (CN); Mengxiao HUANG, Jinan (CN); Shuwang ZHOU, Jinan (CN); Zhaoyang LIU, Jinan (CN); Pengyao XU, Jinan (CN)

(73) Assignees: Qilu University of Technology (Shandong Academy of Sciences), Jinan (CN); Shandong Artificial Intelligence Institute, Jinan (CN); SHANDONG COMPUTER SCIENCE CENTER (NATIONAL SUPERCOMPUTING CENTER IN JINAN), Jinan (CN)

(21) Appl. No.: 18/755,736

(22) Filed: Jun. 27, 2024

(30) Foreign Application Priority Data
Nov. 22, 2023 (CN) 2023115612141

(51) Int. Cl. G06T 1/00; G06V 40/16; G06V 40/40

(52) U.S. Cl. CPC G06T 1/005; G06V 40/168; G06V 40/40

(57) ABSTRACT

An active-defense detection method based on facial landmark watermarking is provided. The active-defense detection method includes: extracting facial landmarks from an original image, converting the extracted facial landmarks into a binary watermark, embedding the binary watermark into the original image to form a watermark image, and subjecting the watermark image to a non-malicious/malicious operation to form a noise image or a malicious image such that a model is robust to the non-malicious/malicious operation. By introducing the facial landmarks, the active-defense detection method can generate a unique watermark for each individual and achieve traceability and detection functions.

### CROSS-REFERENCE TO THE RELATED APPLICATIONS

This application is based upon and claims priority to Chinese Patent Application No. 202311561214.1, filed on Nov. 22, 2023, the entire contents of which are incorporated herein by reference.

### TECHNICAL FIELD

The present disclosure relates to the field of Deepfake detection, and in particular to an active-defense detection method based on facial landmark watermarking.

### BACKGROUND

In recent years, Deepfake technology has entered an increasing number of fields in academia and industry, and has been widely used in multimedia forms such as video, audio, and images to generate fake multimedia products, resulting in various legal and ethical issues. In order to combat the aggressiveness of Deepfake technology, a new research branch called Deepfake detection has emerged. Currently, Deepfake detection mainly focuses on passive detection, that is, detection by artifacts in fake faces after generation. Passive detection methods usually only rely on passive defense and ex-post evidence collection when detecting deeply faked images or videos. This means that they cannot prevent the generation and propagation of deepfakes, and cannot avoid the potential harm caused by fake content.

At present, in methods based on semi-fragile watermarks, a watermark can be used to detect authenticity but cannot achieve tracing. In addition, in methods based on robust watermarks, the watermark embedded into the image is a randomly generated or fixed watermark, and unique watermarks cannot be generated for each individual.

### SUMMARY

In order to overcome the above shortcomings in the prior art, the present disclosure provides an active-defense detection method based on facial landmark watermarking, which can generate unique watermarks for each individual and achieve traceability and detection functions.

In order to solve the technical problem, the present disclosure adopts the following technical solution.

The active-defense detection method based on facial landmark watermarking includes the following steps:
a) acquiring n facial images to form a facial image set I, I={I₁, I₂, . . . , Iᵢ . . . , Iₙ}, where Iᵢ denotes an i-th facial image, i∈{1, . . . , n}; and preprocessing the i-th facial image Iᵢ, i ∈ {1, . . . ,n}, to acquire a preprocessed i-th facial image I_{cover_i}, thereby acquiring a preprocessed facial image set I_{cover};
b) extracting facial landmarks from the preprocessed i-th facial image I_{cover_i}, and converting the facial landmarks into a watermark Wₘ;
c) constructing an encoder, and inputting the i-th facial image I_{cover_i} and the watermark Wₘ into the encoder to acquire a watermark image I_{wm};
d) injecting the watermark image I_{wm} into a noise pool to acquire a noise image Iₙₒᵢₛₑ, and injecting the watermark image I_{wm} into a malicious pool to acquire a malicious image I_{dep};
e) constructing a decoder, and inputting the noise image Iₙₒᵢₛₑ or the malicious image I_{dep} into the decoder to acquire a final watermark Wₘ₁; and
f) determining whether the noise image Iₙₒᵢₛₑ and the malicious image I_{dep} are real or fake images based on the final watermark Wₘ₁.

Further, the step a) includes:
a-1) acquiring the n facial images from a CelebA-HQ dataset to form the facial image set I; and
a-2) resizing, by a resize( ) function in a Python imaging library (PIL), the i-th facial image Iᵢ into a 256×256 image, thereby acquiring the preprocessed i-th facial image I_{cover_i} and acquiring the preprocessed facial image set I_{cover}={I_{cover_1}, I_{cover_2}, . . . , I_{cover_i}, . . . , I_{cover_n}}.

Further, the step b) includes:
b-1) detecting, by a Dlib facial landmark detection algorithm, the facial landmarks in the preprocessed i-th facial image I_{cover_i} to acquire a facial landmark set Lm including m facial landmarks, Lₘ={l₁, l₂, . . . , lₘ}, m=68, where {l₁,l₂, . . . ,l₁₇} are landmarks of a jawline, {l₁₈, l₁₉, . . . , l₂₂} are landmarks of a right eyebrow, {l₂₃, l₂₄, . . . ,l₂₇} are landmarks of a left eyebrow, {l₂₈, l₂₉, . . . ,l₃₆} are landmarks of a nose, {l₃₇, l₃₈, . . . ,l₄₂} are landmarks of a right eye, {l₄₃, l₄₄, . . . , l₄₈} are landmarks of a left eye, and {l₄₉,l₅₀, . . . ,l₆₈} are landmarks of a mouth; and
b-2) defining an i-th landmark lᵢ by a horizontal coordinate xᵢ and a vertical coordinate yᵢ; mapping a value of the horizontal coordinate xᵢ to an integer range of 0-15 through a linear transformation, and converting, by a bin( ) function in Python, the value into a binary representation Wₓ_{ᵢ} with a length of 4; mapping a value of the vertical coordinate yᵢ to an integer range of 0-15 through a linear transformation, and converting, by the bin( ) function in Python, the value into a binary representation W_{y}_{ᵢ} with a length of 4; splicing the binary representation Wₓ_{ᵢ} and the binary representation W_{y}_{ᵢ} into a binary representation W_{xy}_{₋ᵢ} with a length of 8; splicing binary representations of the 68 facial landmarks together into a binary representation W₆₈ with a length of 544; and compressing, by a principal component analysis (PCA)-based dimensionality reduction method, the binary representation W₆₈ to a binary representation with a length of 256 as the watermark Wₘ.

Further, the step c) includes:
c-1) constructing the encoder, including an original image processing unit, a watermark processing unit, a first convolutional layer, a batch normalization (BatchNorm) layer, an activation function layer, and a second convolutional layer;
c-2) constructing the original image processing unit of the encoder, including a convolutional layer, a BatchNorm layer, a first rectified linear unit (ReLU) activation function, an atrous convolutional layer, a second ReLU activation function, a Dropout layer, a first combined pooling and convolution (CPC) module, a second CPC module, and a third CPC module; inputting the i-th facial image I_{cover_i} into the convolutional layer, the BatchNorm layer, and the first ReLU activation function of the original image processing unit in sequence to acquire an image feature F_{cover_1}; and inputting the image feature F_{cover_1} into the atrous convolutional layer, the second ReLU activation function, and the Dropout layer of the original image processing unit in sequence to acquire an image feature F_{cover_2};
c-3) constructing the first CPC module, the second CPC module, and the third CPC module, each including a first branch and a second branch, where the first branch includes a first convolutional layer, a first BatchNorm layer, a first ReLU activation function, a second convolutional layer, a second BatchNorm layer, a second ReLU activation function, a third convolutional layer, a third BatchNorm layer, and a third ReLU activation function in sequence, while the second branch includes an average pooling layer, a first convolutional layer, a ReLU activation function, and a second convolutional layer in sequence; inputting the image feature F_{cover_2} into the first convolutional layer, the first BatchNorm layer, and the first ReLU activation function in the first branch of the first CPC module in sequence to acquire an image feature F_{cover_2_1}; inputting the image feature F_{cover_2_1} into the second convolutional layer, the second BatchNorm layer, and the second ReLU activation function in the first branch of the first CPC module in sequence to acquire an image feature F_{cover_2_2}; inputting the image feature F_{cover_2_2} into the third convolutional layer, the third BatchNorm layer, and the third ReLU activation function in the first branch of the first CPC module in sequence to acquire an image feature F_{cover_2_3}; inputting the image feature F_{cover_2} into the second branch of the first CPC module to acquire an image feature F_{cover_3}; subjecting the image feature F_{cover_3} and the image feature F_{cover_2_3} to element-wise multiplication to acquire an image feature F_{cover_4}; subjecting the image feature F_{cover_4} and the image feature F_{cover_2} to corresponding-elements addition to acquire an image feature F_{cover_5}; inputting the image feature F_{cover_5} into the first convolutional layer, the first BatchNorm layer, and the first ReLU activation function in the first branch of the second CPC module in sequence to acquire an image feature F_{cover_5_1}; inputting the image feature F_{cover_5_1} into the second convolutional layer, the second BatchNorm layer, and the second ReLU activation function in the first branch of the second CPC module in sequence to acquire an image feature F_{cover_5_2}; inputting the image feature F_{cover_5_2} into the third convolutional layer, the third BatchNorm layer, and the third ReLU activation function in the first branch of the second CPC module in sequence to acquire an image feature F_{cover_5_3}; inputting the image feature F_{cover_5} into the second branch of the second CPC module to acquire an image feature F_{cover_6}; subjecting the image feature F_{cover_6} and the image feature F_{cover_5_3} to element-wise multiplication to acquire an image feature F_{cover_7}; subjecting the image feature F_{cover_7} and the image feature F_{cover_5} to corresponding-elements addition to acquire an image feature F_{cover_8}; inputting the image feature F_{cover_8} into the first convolutional layer, the first BatchNorm layer, and the first ReLU activation function in the first branch of the third CPC module in sequence to acquire an image feature F_{cover_8_1}; inputting the image feature F_{cover_8_1} into the second convolutional layer, the second BatchNorm layer, and the second ReLU activation function in the first branch of the third CPC module in sequence to acquire an image feature F_{cover_8_2}; inputting the image feature F_{cover_8_2} into the third convolutional layer, the third BatchNorm layer, and the third ReLU activation function in the first branch of the third CPC module in sequence to acquire an image feature F_{cover_8_3}; inputting the image feature F_{cover_8} into the second branch of the third CPC module to acquire an image feature F_{cover_9}; subjecting the image feature F_{cover_9} and the image feature F_{cover_8_3} to element-wise multiplication to acquire an image feature F_{cover_10}; and subjecting the image feature F_{cover_10} and the image feature F_{cover_8} to corresponding-elements addition to acquire an image feature F_{cover_11};
c-4) constructing the watermark processing unit of the encoder, including a linear layer, a convolutional layer, a first BatchNorm layer, a first ReLU activation function, an atrous convolutional layer, a second ReLU activation function, a first Dropout layer, a first deconvolutional layer, a second BatchNorm layer, a third ReLU activation function, a second deconvolutional layer, a fourth ReLU activation function, a second Dropout layer, a first CPC module, a second CPC module, and a third CPC module; inputting the watermark Wₘ into the linear layer of the watermark processing unit to acquire a watermark feature f₁; inputting the watermark feature f₁ into the convolutional layer, the first BatchNorm layer, and the first ReLU activation function of the watermark processing unit in sequence to acquire a watermark feature f₂; inputting the watermark feature f₂ into the atrous convolutional layer, the second ReLU activation function, and the first Dropout layer of the watermark processing unit in sequence to acquire a watermark feature f₃; inputting the watermark feature f₃ into the first deconvolutional layer, the second BatchNorm layer, and the third ReLU activation function of the watermark processing unit in sequence to acquire a watermark feature f₄; inputting the watermark feature f₄ into the second deconvolutional layer, the fourth ReLU activation function, and the second Dropout layer of the watermark processing unit in sequence to acquire a watermark feature f₅; inputting the watermark feature f₅ into the first convolutional layer, the first BatchNorm layer, and the first ReLU activation function in the first branch of the first CPC module in sequence to acquire a watermark feature f_{m_5_1}; inputting the watermark feature f_{m_5_1} into the second convolutional layer, the second BatchNorm layer, and the second ReLU activation function in the first branch of the first CPC module in sequence to acquire a watermark feature f_{m_5_2}; inputting the watermark feature f_{m_5_2} into the third convolutional layer, the third BatchNorm layer, and the third ReLU activation function in the first branch of the first CPC module in sequence to acquire a watermark feature f_{m_5_3}; inputting the watermark feature f₅ into the second branch of the first CPC module to acquire a watermark feature f_{m_6}; subjecting the watermark feature f_{m_6} and the watermark feature f_{m_5_3} to element-wise multiplication to acquire a watermark feature f_{m_7}; subjecting the watermark feature f_{m_7} and the watermark feature f₅ to corresponding-elements addition to acquire a watermark feature f_{m_8}; inputting the watermark feature f_{m_8} into the first convolutional layer, the first BatchNorm layer, and the first ReLU activation function in the first branch of the second CPC module in sequence to acquire a watermark feature f_{m_8_1}; inputting the watermark feature f_{m_8_1} into the second convolutional layer, the second BatchNorm layer, and the second ReLU activation function in the first branch of the second CPC module in sequence to acquire a watermark feature f_{m_8_2}; inputting the watermark feature f_{m_8_2} into the third convolutional layer, the third BatchNorm layer, and the third ReLU activation function in the first branch of the second CPC module in sequence to acquire a watermark feature f_{m_8_3}; inputting the watermark feature f_{m_8} into the second branch of the second CPC module to acquire a watermark feature f_{m_9}; subjecting the watermark feature f_{m_9} and the watermark feature f_{m_8_3} to element-wise multiplication to acquire a watermark feature f_{m_10}; subjecting the watermark feature f_{m_10} and the watermark feature f_{m_8} to corresponding-elements addition to acquire a watermark feature f_{m_11}; inputting the watermark feature f_{m_11} into the first convolutional layer, the first BatchNorm layer, and the first ReLU activation function in the first branch of the third CPC module in sequence to acquire a watermark feature f_{m_11_1}; inputting the watermark feature f_{m_11_1} into the second convolutional layer, the second BatchNorm layer, and the second ReLU activation function in the first branch of the third CPC module in sequence to acquire a watermark feature f_{m_11_2}; inputting the watermark feature f_{m_11_2} into the third convolutional layer, the third BatchNorm layer, and the third ReLU activation function in the first branch of the third CPC module in sequence to acquire a watermark feature f_{m_11_3}; inputting the watermark feature f_{m_11} into the second branch of the third CPC module to acquire a watermark feature f_{m_12}; subjecting the watermark feature f_{m_12} and the watermark feature f_{m_11_3} to element-wise multiplication to acquire a watermark feature f_{m_13}; and subjecting the watermark feature f_{m_13} and the watermark feature f_{m_11} to corresponding-elements addition to acquire a watermark feature f₆; and
c-5) subjecting the image feature F_{cover_11} and the watermark feature f₆ to corresponding-elements addition to acquire a feature F₁; inputting the feature F₁ into the first convolutional layer, the BatchNorm layer, and the activation function layer of the encoder in sequence to acquire a feature F₂; and inputting the feature F₂ into the second convolutional layer of the encoder to acquire the watermark image I_{wm}.

Preferably, in the step c-2), the convolutional layer of the original image processing unit includes 64 channels and a convolutional kernel, with a size of 3, a stride of 1, and a padding of 1; and the atrous convolutional layer of the original image processing unit includes 64 channels and a convolutional kernel, with a size of 3, a dilation rate of 2, a stride of 1, and a padding of 1; in the step c-3), the first convolutional layer, the second convolutional layer, and the third convolutional layer in the first branch each include 64 channels and a convolutional kernel, with a size of 3, a stride of 1, and a padding of 1; the first convolutional layer and the second convolutional layer in the second branch each include 64 channels and a convolutional kernel, with a size of 3, a stride of 1, and a padding of 1; and the average pooling layer in the second branch has a window size of 4; in the step c-4), the linear layer of the watermark processing unit includes 256 input nodes and 256 output nodes; the convolutional layer of the watermark processing unit includes 64 channels and a convolutional kernel, with a size of 3, a stride of 1, and a padding of 1; the atrous convolutional layer of the watermark processing unit includes 64 channels and a convolutional kernel, with a size of 3, a dilation rate of 2, a stride of 1, and a padding of 1; and the first deconvolutional layer and the second deconvolutional layer of the watermark processing unit each include 64 channels and a convolutional kernel, with a size of 3, a stride of 1, and a padding of 1; in the step c-5), the first convolutional layer of the encoder includes 64 channels and a convolutional kernel, with a size of 3, a stride of 1, and a padding of 1; and the second convolutional layer of the encoder includes 3 channels and a convolutional kernel, with a size of 1, a stride of 1, and a padding of 1.

Further, the step d) includes:
d-1) constructing the noise pool, including Identity noise, Dropout noise, Crop noise, GaussianNoise noise, SaltPepper noise, GaussianBlur noise, MedBlur noise, and joint photographic experts group (JPEG) noise; injecting the watermark image I_{wm} into the noise pool; and adding a noise randomly selected from the noise pool to the watermark image I_{wm} to form the noise image Iₙₒᵢₛₑ; and
d-2) constructing the malicious pool, including a simple swapping (SimSwap) model, an information bottleneck disentanglement for identity swapping (InfoSwap) model, a unified cross-entropy loss for deep face recognition (UniFace) model, and attribute manipulation algorithms; injecting the watermark image I_{wm} into the malicious pool; and manipulating, by a model or attribute manipulation algorithm randomly selected from the malicious pool, the watermark image I_{wm} to form the malicious image I_{dep}.

Further, the step e) includes:
e-1) constructing the decoder, including a first convolutional layer, a first BatchNorm layer, a first ReLU activation function, a first atrous convolutional layer, a second ReLU activation function, a first Dropout layer, a first CPC module, a second CPC module, a third CPC module, a second convolutional layer, a second BatchNorm layer, a third ReLU activation function, a second atrous convolutional layer, a fourth ReLU activation function, a second Dropout layer, a flatten layer, and a fully connected layer; inputting the noise image Iₙₒᵢₛₑ or the malicious image I_{dep} into the first convolutional layer, the first BatchNorm layer, and the first ReLU activation function of the decoder in sequence to acquire an image feature N₁; inputting the image feature N₁ into the first atrous convolutional layer, the second ReLU activation function, and the first Dropout layer of the decoder in sequence to acquire an image feature N₂; inputting the image feature N₂ into the first convolutional layer, the first BatchNorm layer, and the first ReLU activation function in the first branch of the first CPC module in sequence to acquire an image feature N_{2_1}; inputting the image feature N_{2_1} into the second convolutional layer, the second BatchNorm layer, and the second ReLU activation function in the first branch of the first CPC module in sequence to acquire an image feature N_{2_2}; inputting the image feature N_{2_2} into the third convolutional layer, the third BatchNorm layer, and the third ReLU activation function in the first branch of the first CPC module in sequence to acquire an image feature N_{2_3}; inputting the image feature N₂ into the second branch of the first CPC module to acquire an image feature N₃; subjecting the image feature N₃ and the image feature N_{2_3} to element-wise multiplication to acquire an image feature N₄; subjecting the image feature N₄ and the image feature N₂ to corresponding-elements addition to acquire an image feature N₅; inputting the image feature N₅ into the first convolutional layer, the first BatchNorm layer, and the first ReLU activation function in the first branch of the second CPC module in sequence to acquire an image feature N_{5_1}; inputting the image feature N_{5_1} into the second convolutional layer, the second BatchNorm layer, and the second ReLU activation function in the first branch of the second CPC module in sequence to acquire an image feature N_{5_2}; inputting the image feature N_{5_2} into the third convolutional layer, the third BatchNorm layer, and the third ReLU activation function in the first branch of the second CPC module in sequence to acquire an image feature N_{5_3}; inputting the image feature N₅ into the second branch of the second CPC module to acquire an image feature N₆; subjecting the image feature N₆ and the image feature N_{5_3} to element-wise multiplication to acquire an image feature N₇; subjecting the image feature N₇ and the image feature N₅ to corresponding-elements addition to acquire an image feature N₈; inputting the image feature N₈ into the first convolutional layer, the first BatchNorm layer, and the first ReLU activation function in the first branch of the third CPC module in sequence to acquire an image feature N_{8_1}; inputting the image feature N_{8_1} into the second convolutional layer, the second BatchNorm layer, and the second ReLU activation function in the first branch of the third CPC module in sequence to acquire an image feature N_{8_2}; inputting the image feature N_{8_2} into the third convolutional layer, the third BatchNorm layer, and the third ReLU activation function in the first branch of the third CPC module in sequence to acquire an image feature N_{8_3}; inputting the image feature N₈ into the second branch of the third CPC module to acquire an image feature N₉; subjecting the image feature N₉ and the image feature N_{8_3} to element-wise multiplication to acquire an image feature N₁₀; subjecting the image feature N₁₀ and the image feature N₈ to corresponding-elements addition to acquire an image feature N₁₁; inputting the image feature N₁₁ into the second convolutional layer, the second BatchNorm layer, and the third ReLU activation function of the decoder in sequence to acquire an image feature N₁₂; inputting the image feature N₁₂ into the second atrous convolutional layer, the fourth ReLU activation function, and the second Dropout layer of the decoder in sequence to acquire an image feature N; inputting the image feature N₁₃ into the flatten layer of the decoder to acquire an image feature N₁₄; and inputting the image feature N₁₄ into the fully connected layer of the decoder to acquire the final watermark Wₘ₁.

Preferably, in the step e-1), the first convolutional layer of the decoder includes 64 channels and a convolutional kernel, with a size of 3, a stride of 1, and a padding of 1; the first atrous convolutional layer of the decoder includes 64 channels and a convolutional kernel, with a size of 3, a dilation rate of 2, a stride of 1, and a padding of 1; the second convolutional layer of the decoder includes 64 channels and a convolutional kernel, with a size of 3, a stride of 1, and a padding of 1; the second atrous convolutional layer of the decoder includes 64 channels and a convolutional kernel, with a size of 3, a dilation rate of 2, a stride of 1, and a padding of 1; and the flatten layer and the fully connected layer of the decoder each include 256 neurons.

Further, the step f) includes:
f-1) defining a constant count1 with an initial value of 0; determining whether binary values at corresponding positions of the final watermark Wₘ₁ and the watermark Wₘ are the same; and if the binary values of the final watermark Wₘ₁ and the watermark Wₘ are different in one bit: incrementing the constant count1 by 1, and dividing a final value of the constant count1 by 256 to acquire a bit error rate E_{bit};
f-2) determining that the noise image Iₙₒᵢₛₑ is areal image if the bit error rate E_{bit} is less than 0.5; and determining that the noise image Iₙₒᵢₛₑ is a fake image if the bit error rate E_{bit} is greater than or equal to 0.5;
f-3) replacing the i-th facial image I_{cover_i} in the step b) with the malicious image I_{dep}, and repeating the step b) to acquire a watermark W′ₘ;
f-4) defining a constant count2 with an initial value of 0; determining whether binary values at corresponding positions of the watermark W′ₘ and the watermark Wₘ are the same; and if the binary values of the watermark W′ₘ and the watermark Wₘ are different in one bit: incrementing the constant count2 by 1, and dividing a final value of the constant count2 by 256 to acquire a bit error rate E′ₘᵢₙ; and
f-5) determining that the malicious image I_{dep} is a real image if the bit error rate E′_{bit}, is less than or equal to 0.5; and determining that the malicious image I_{dep} is a fake image if the bit error rate E′_{bit}, is greater than 0.5.

The present disclosure has the following beneficial effects. The present disclosure extracts facial landmarks from an original image and converts the extracted facial landmarks into a binary watermark. The present disclosure embeds the binary watermark into the original image to acquire a watermark image, allowing the watermark image to undergo a non-malicious/malicious operation to form a noise image or a malicious image. In this way, the model is robust to the non-malicious/malicious operation. The present disclosure introduces facial landmarks to generate a unique watermark for each individual and achieve traceability and detection functions.

### BRIEF DESCRIPTION OF THE DRAWINGS

FIG. 1 is a flowchart of an active-defense detection method based on facial landmark watermarking according to the present disclosure;

FIG. 2 is a structural diagram of landmark extraction according to the present disclosure;

FIG. 3 is a structural diagram of an encoder according to the present disclosure; and

FIG. 4 is a structural diagram of a decoder according to the present disclosure.

### DETAILED DESCRIPTION OF THE EMBODIMENTS

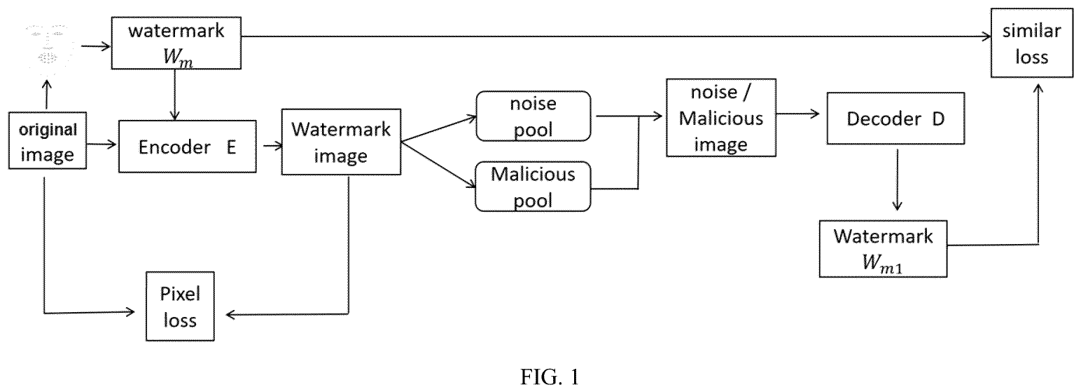

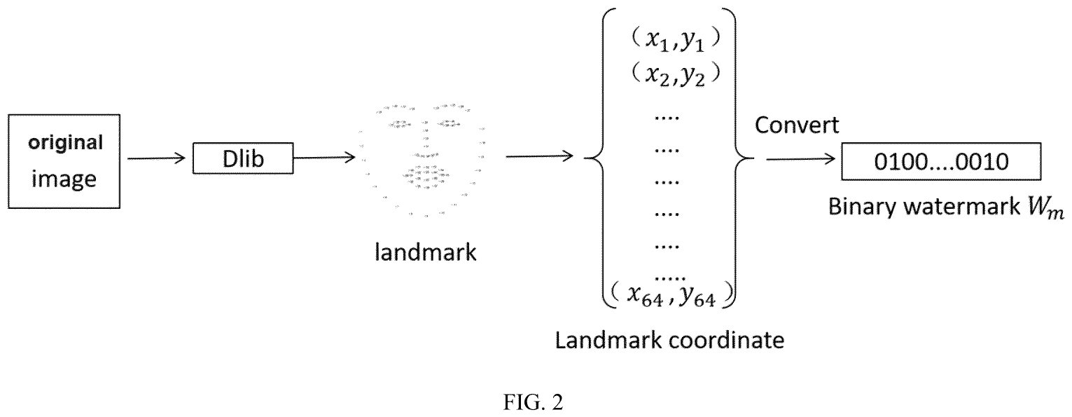

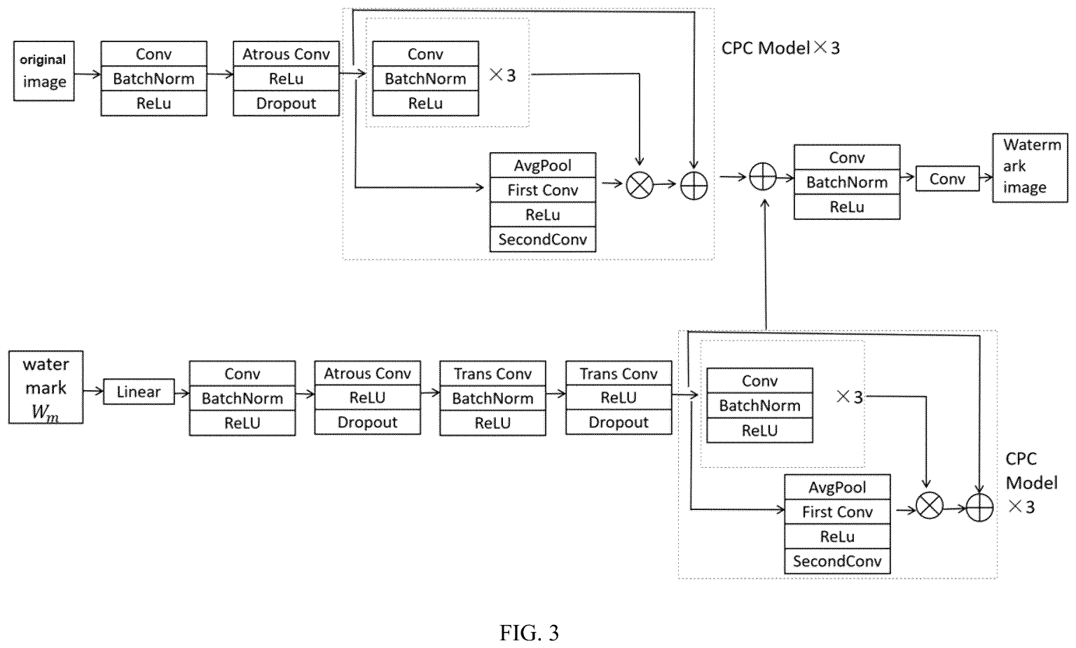

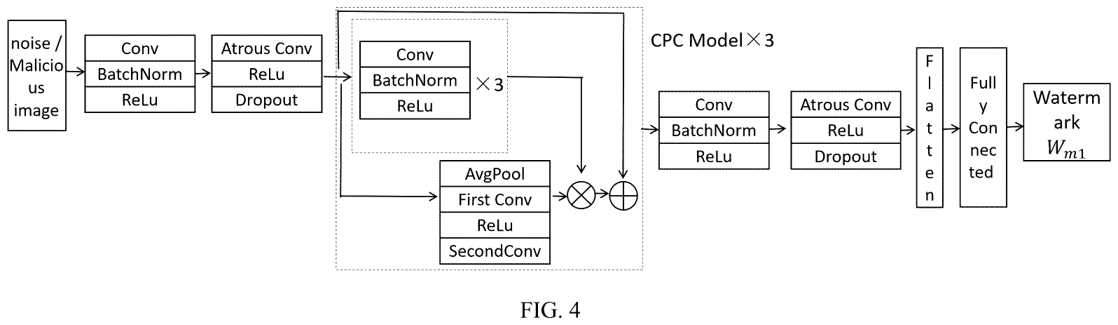

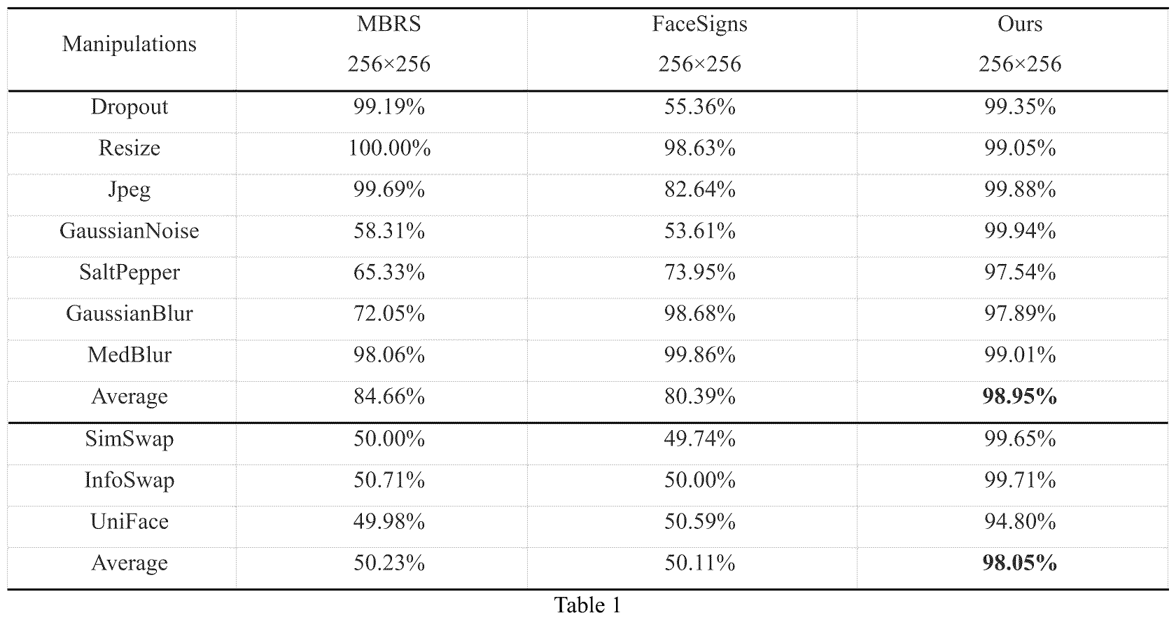

The present disclosure is further described with reference to FIGS. 1 to 4.

An active-defense detection method based on facial landmark watermarking includes the following steps.

a) n facial images are acquired to form facial image set I I=(I₁, I₂, . . . , Iᵢ, . . . , Iₙ, where I, denotes an i-th facial image, i ∈{1, . . . , n}. The i-th facial image Iᵢ, i ∈ {1, . . . ,n}, is preprocessed to acquire preprocessed i-th facial image I_{cover_i}, thereby acquiring preprocessed facial image set I_{cover}.

b) Facial landmarks are extracted from the preprocessed i-th facial image I_{cover_i}, and are converted is input into watermark Wₘ.

c) An encoder is constructed, and the i-th facial image I_{cover_i} and the watermark Wₘ are input is input into the encoder to acquire watermark image I_{wm}.

d) The watermark image I_{wm} is injected into a noise pool to acquire noise image Iₙₒᵢₛₑ, and the watermark image I_{wm} is injected into a malicious pool to acquire malicious image I_{dep}.

e) A decoder is constructed, and the noise image Iₙₒᵢₛₑ or the malicious image I_{dep} is input into the decoder to acquire final watermark Wₘ₁.

f) it is determined whether the noise image Iₙₒᵢₛₑ and the malicious image I_{dep} are real or fake images based on the final watermark Wₘ₁.

The present disclosure converts the extracted facial landmarks is input into a binary watermark. The present disclosure embeds the binary watermark is input into the original image to acquire watermark image, allowing the watermark image to undergo a non-malicious/malicious operation to form noise image. In this way, the model is robust to the non-malicious/malicious operation. The present disclosure can generate a unique watermark for each individual and achieve traceability and detection functions. The present disclosure is based on the idea of adversarial attacks. Typically, active defense involves two methods. Firstly, adversarial perturbations are added to images or videos to distort the content generated by Deepfake, achieving the effect of “knowing it is fake at a glance”. Secondly, adversarial watermarks are added to images or videos. Unlike adding perturbations, adding watermarks is done by training the robustness of the watermark. At present, in methods based on semi-fragile watermarks, a watermark can only detect authenticity and cannot achieve tracing. In addition, in methods based on robust watermarks, watermarks embed is input into the image are randomly generated or fixed watermarks, and unique watermarks cannot be generated for each individual.

In an embodiment of the present disclosure, the step a) is as follows.

a-1) The n facial images are acquired from a CelebA-HQ dataset to form the facial image set I. The CelebA-HQ dataset includes 30,000 facial images with different identities, each with a resolution of 1024*1024.

a-2) The i-th facial image Iᵢ is resized by a resize( ) function in a Python imaging library (PIL) into a 256×256 image, thereby acquiring the preprocessed i-th facial image I_{cover_i} and acquiring the preprocessed facial image set I_{cover}={I_{cover_1}, I_{cover_2}, . . . , I_{cover_i}, . . . , I_{cover_n}}.

In an embodiment of the present disclosure, the step b) is as follows.

b-1) The facial landmarks in the preprocessed i-th facial image I_{cover_i} are detected by a Dlib facial landmark detection algorithm to acquire facial landmark set Lₘ including m facial landmarks, Lₘ={l₁,l₂, . . . ,lₘ}, m=68, where {l₁,l₂, . . . , l₁₇} are landmarks of a jawline, {l₁₈, l₁₉, . . . , l₂₂} are landmarks of a right eyebrow, {l₂₃,l₂₄, . . . ,l₂₇} are landmarks of a left eyebrow, {l₂₈, l₂₉, . . . , l₃₆} are landmarks of a nose, {l₃₇,l₃₈, . . . ,l₄₂} are landmarks of a right eye, {l₄₃,l₄₄′, . . . , l₄₈} are landmarks of a left eye, and {l₄₉,l₅₀, . . . ,l₆₈} are landmarks of a mouth.

b-2) i-th landmark lᵢ is defined by horizontal coordinate x, and vertical coordinate yᵢ. A value of the horizontal coordinate xᵢ is mapped to an integer range of 0-15 through a linear transformation, and the value is converted by a bin( ) function in Python into binary representation Wₓ_{ᵢ} with a length of 4. A value of the vertical coordinate yᵢ is mapped to an integer range of 0-15 through a linear transformation, and the value is converted by the bin( ) function in Python into binary representation W_{y}_{ᵢ} with a length of 4. The binary representation Wₓ_{ᵢ} and the binary representation W_{y}_{ᵢ} are spliced into binary representation W_{xy}_{₋ᵢ} with a length of 8. Binary representations of the 68 facial landmarks are spliced together input into binary representation W₆₈ with a length of 544. The binary representation W₆₈ is compressed by a principal component analysis (PCA)-based dimensionality reduction method to a binary representation with a length of 256 as the watermark Wₘ.

In an embodiment of the present disclosure, the step c) is as follows.

c-1) The encoder is constructed, including an original image processing unit, a watermark processing unit, a first convolutional layer, a batch normalization (BatchNorm) layer, an activation function layer, and a second convolutional layer.

c-2) The original image processing unit of the encoder is constructed, including a convolutional layer, a BatchNorm layer, a first rectified linear unit (ReLU) activation function, an atrous convolutional layer, a second ReLU activation function, a Dropout layer, a first CPC module, a second CPC module, and a third CPC module. The i-th facial image I_{cover_i} is input into the convolutional layer, the BatchNorm layer, and the first ReLU activation function of the original image processing unit in sequence to acquire image feature F_{cover_1}. The image feature F_{cover_1} is input into the atrous convolutional layer, the second ReLU activation function, and the Dropout layer of the original image processing unit in sequence to acquire image feature F_{cover_2}.

c-3) The first CPC module, the second CPC module, and the third CPC module are constructed, each including a first branch and a second branch, where the first branch includes a first convolutional layer, a first BatchNorm layer, a first ReLU activation function, a second convolutional layer, a second BatchNorm layer, a second ReLU activation function, a third convolutional layer, a third BatchNorm layer, and a third ReLU activation function in sequence, while the second branch includes an average pooling layer, a first convolutional layer, a ReLU activation function, and a second convolutional layer in sequence. The image feature F_{cover_2} is input into the first convolutional layer, the first BatchNorm layer, and the first ReLU activation function in the first branch of the first CPC module in sequence to acquire image feature F_{cover_2_1}. The image feature F_{cover_2_1} is input into the second convolutional layer, the second BatchNorm layer, and the second ReLU activation function in the first branch of the first CPC module in sequence to acquire image feature F_{cover_2_2}. The image feature F_{cover_2_2} is input into the third convolutional layer, the third BatchNorm layer, and the third ReLU activation function in the first branch of the first CPC module in sequence to acquire image feature F_{cover_2_3}. The image feature F_{cover_2} is input into the second branch of the first CPC module to acquire image feature F_{cover_3}. The image feature F_{cover_3} and the image feature F_{cover_2_3} are subjected to element-wise multiplication to acquire image feature F_{cover_4}. The image feature F_{cover_4} and the image feature F_{cover_2} are subjected to corresponding-elements addition to acquire image feature F_{cover_5}. The image feature F_{cover_5} is input into the first convolutional layer, the first BatchNorm layer, and the first ReLU activation function in the first branch of the second CPC module in sequence to acquire image feature F_{cover_5_1}. The image feature F_{cover_5_1} is input into the second convolutional layer, the second BatchNorm layer, and the second ReLU activation function in the first branch of the second CPC module in sequence to acquire image feature F_{cover_5_2}. The image feature F_{cover_5_2} is input into the third convolutional layer, the third BatchNorm layer, and the third ReLU activation function in the first branch of the second CPC module in sequence to acquire image feature F_{cover_5_3}. The image feature F_{cover_5} is input into the second branch of the second CPC module to acquire image feature F_{cover_6}. The image feature F_{cover_6} and the image feature F_{cover_5_3} are subjected to element-wise multiplication to acquire image feature F_{cover_7}. The image feature F_{cover_7} and the image feature F_{cover_5} are subjected to corresponding-elements addition to acquire image feature F_{cover_8}. The image feature F_{cover_8} is input into the first convolutional layer, the first BatchNorm layer, and the first ReLU activation function in the first branch of the third CPC module in sequence to acquire image feature F_{cover_8_1}. The image feature F_{cover_8_1} is input into the second convolutional layer, the second BatchNorm layer, and the second ReLU activation function in the first branch of the third CPC module in sequence to acquire image feature F_{cover_8_2}. The image feature F_{cover_8_2} is input into the third convolutional layer, the third BatchNorm layer, and the third ReLU activation function in the first branch of the third CPC module in sequence to acquire image feature F_{cover_8_3}. The image feature F_{cover_8} is input into the second branch of the third CPC module to acquire image feature F_{cover_9}. The image feature F_{cover_9} and the image feature F_{cover_8_3} are subjected to element-wise multiplication to acquire image feature F_{cover_1}. The image feature F_{cover_10} and the image feature F_{cover_8} are subjected to corresponding-elements addition to acquire image feature F_{cover_11}.

c-4) The watermark processing unit of the encoder is constructed, including a linear layer, a convolutional layer, a first BatchNorm layer, a first ReLU activation function, an atrous convolutional layer, a second ReLU activation function, a first Dropout layer, a first deconvolutional layer, a second BatchNorm layer, a third ReLU activation function, a second deconvolutional layer, a fourth ReLU activation function, a second Dropout layer, a first CPC module, a second CPC module, and a third CPC module. The watermark Wₘ is input into the linear layer of the watermark processing unit to acquire watermark feature f₁. The watermark feature f₁ is input into the convolutional layer, the first BatchNorm layer, and the first ReLU activation function of the watermark processing unit in sequence to acquire watermark feature f₂. The watermark feature f₂ is input into the atrous convolutional layer, the second ReLU activation function, and the first Dropout layer of the watermark processing unit in sequence to acquire watermark feature f₃. The watermark feature f₃ is input into the first deconvolutional layer, the second BatchNorm layer, and the third ReLU activation function of the watermark processing unit in sequence to acquire watermark feature f₄. The watermark feature f₄ is input into the second deconvolutional layer, the fourth ReLU activation function, and the second Dropout layer of the watermark processing unit in sequence to acquire watermark feature f₅. The watermark feature f₅ is input into the first convolutional layer, the first BatchNorm layer, and the first ReLU activation function in the first branch of the first CPC module in sequence to acquire watermark feature f_{m_5_1}. The watermark feature f_{m_5_1} is input into the second convolutional layer, the second BatchNorm layer, and the second ReLU activation function in the first branch of the first CPC module in sequence to acquire watermark feature f_{m_5_2}. The watermark feature f_{m_5_2} is input into the third convolutional layer, the third BatchNorm layer, and the third ReLU activation function in the first branch of the first CPC module in sequence to acquire watermark feature f_{m_5_3}. The watermark feature f₅ is input into the second branch of the first CPC module to acquire watermark feature f_{m_6}. The watermark feature f_{m_6} and the watermark feature f_{m_5_3} are subjected to element-wise multiplication to acquire watermark feature f_{m_7}. The watermark feature f_{m_7} and the watermark feature f₅ are subjected to corresponding-elements addition to acquire watermark feature f_{m_8}. The watermark feature f_{m_8} is input into the first convolutional layer, the first BatchNorm layer, and the first ReLU activation function in the first branch of the second CPC module in sequence to acquire watermark feature f_{m_8_1}. The watermark feature f_{m_8_1} is input into the second convolutional layer, the second BatchNorm layer, and the second ReLU activation function in the first branch of the second CPC module in sequence to acquire watermark feature f_{m_8_2}. The watermark feature f_{m_8_2} is input into the third convolutional layer, the third BatchNorm layer, and the third ReLU activation function in the first branch of the second CPC module in sequence to acquire watermark feature f_{m_8_3}. The watermark feature f_{m_8} is input into the second branch of the second CPC module to acquire watermark feature f_{m_9}. The watermark feature f_{m_9} and the watermark feature f_{m_8_3} are subjected to element-wise multiplication to acquire watermark feature f_{m_10}. The watermark feature f_{m_10} and the watermark feature f_{m_8} are subjected to corresponding-elements addition to acquire watermark feature f_{m_11}. The watermark feature f_{m_11} is input into the first convolutional layer, the first BatchNorm layer, and the first ReLU activation function in the first branch of the third CPC module in sequence to acquire watermark feature f_{m_11_1}. The watermark feature f_{m_11_1} is input into the second convolutional layer, the second BatchNorm layer, and the second ReLU activation function in the first branch of the third CPC module in sequence to acquire watermark feature f_{m_11_2}. The watermark feature f_{m_11_2} is input into the third convolutional layer, the third BatchNorm layer, and the third ReLU activation function in the first branch of the third CPC module in sequence to acquire watermark feature f_{m_11_3}. The watermark feature f_{m_11} is input into the second branch of the third CPC module to acquire watermark feature f_{m_12}. The watermark feature f_{m_12} and the watermark feature f_{m_11_3} are subjected to element-wise multiplication to acquire watermark feature f_{m_13}. The watermark feature f_{m_13} and the watermark feature f_{m_11} are subjected to corresponding-elements addition to acquire watermark feature f₆.

c-5) The image feature F_{cover_11} and the watermark feature f₆ are subjected to corresponding-elements addition to acquire feature F₁. The feature F₁ is input into the first convolutional layer, the BatchNorm layer, and the activation function layer of the encoder in sequence to acquire feature F₂. The feature F₂ is input into the second convolutional layer of the encoder to acquire the watermark image I_{wm}.

In the encoder, all convolutional layers, deconvolutional layers, and atrous convolutional layers are two-dimensional.

In this embodiment, preferably, in the step c-2), the convolutional layer of the original image processing unit includes 64 channels and a convolutional kernel, with a size of 3, a stride of 1, and a padding of 1. The atrous convolutional layer of the original image processing unit includes 64 channels and a convolutional kernel, with a size of 3, a dilation rate of 2, a stride of 1, and a padding of 1. in the step c-3), the first convolutional layer, the second convolutional layer, and the third convolutional layer in the first branch each include 64 channels and a convolutional kernel, with a size of 3, a stride of 1, and a padding of 1. The first convolutional layer and the second convolutional layer in the second branch each include 64 channels and a convolutional kernel, with a size of 3, a stride of 1, and a padding of 1. The average pooling layer in the second branch has a window size of 4. In the step c-4), the linear layer of the watermark processing unit includes 256 input nodes and 256 output nodes. The convolutional layer of the watermark processing unit includes 64 channels and a convolutional kernel, with a size of 3, a stride of 1, and a padding of 1. The atrous convolutional layer of the watermark processing unit includes 64 channels and a convolutional kernel, with a size of 3, a dilation rate of 2, a stride of 1, and a padding of 1. The first deconvolutional layer and the second deconvolutional layer of the watermark processing unit each include 64 channels and a convolutional kernel, with a size of 3, a stride of 1, and a padding of 1. In the step c-5), the first convolutional layer of the encoder includes 64 channels and a convolutional kernel, with a size of 3, a stride of 1, and a padding of 1. The second convolutional layer of the encoder includes 3 channels and a convolutional kernel, with a size of 1, a stride of 1, and a padding of 1.

In an embodiment of the present disclosure, the step d) is as follows.

d-1) The noise pool is constructed, including Identity noise, Dropout noise, Crop noise, GaussianNoise noise, SaltPepper noise, GaussianBlur noise, MedBlur noise, and joint photographic experts group (JPEG) noise. The watermark image I_{wm} is injected into the noise pool. A noise randomly selected from the noise pool is added to the watermark image I_{wm} to form the noise image Iₙₒᵢₛₑ. By implementing the source code described in the paper “MBRS: Enhancing Robustness of DNN-based Watermarking by Mini-Batch of Real and Simulated joint photographic experts group (JPEG) Compression”, the Identity noise, Dropout noise, Crop noise, GaussianNoise noise, SaltPepper noise, GaussianBlur noise, MedBlur noise, and joint photographic experts group (JPEG) noise are added. This is available in the prior art and will not be elaborated herein.

d-2) The malicious pool is constructed, including a simple swapping (SimSwap) model, an information bottleneck disentanglement for identity swapping (InfoSwap) model, a unified cross-entropy loss for deep face recognition (UniFace) model, and attribute manipulation algorithms (for manipulating nose, mouth, eyes, jawline, and eyebrow attributes). The watermark image I_{wm} is injected into the malicious pool. The watermark image I_{wm} is manipulated by a model or attribute manipulation algorithm randomly selected from the malicious pool to form the malicious image I_{dep}. The SimSwap model achieves face swapping through the source code described in the paper “SimSwap: An Efficient Framework for High Fidelity Face Swapping”. The InfoSwap model achieves face swapping through the source code described in the paper “InfoSwap: Information Bottleneck Disentengement for Identity Swapping”. The UniFace model achieves face swapping through the source code described in the paper “Designing One Unified Framework for High-Identity Face Reenactment and Swapping”. The manipulating the shape of attributes such as nose, mouth, eyes, jawline, and eyebrows is achieved through the source code described in the paper “StarGAN: Unified Generative Adversarial Networks for Multi-Domain Image-to-Image Translation”. This is available in the prior art and will not be elaborated herein.

In an embodiment of the present disclosure, the step e) is as follows.

e-1) The decoder is constructed, including a first convolutional layer, a first BatchNorm layer, a first ReLU activation function, a first atrous convolutional layer, a second ReLU activation function, a first Dropout layer, a first CPC module, a second CPC module, a third CPC module, a second convolutional layer, a second BatchNorm layer, a third ReLU activation function, a second atrous convolutional layer, a fourth ReLU activation function, a second Dropout layer, a flatten layer, and a fully connected layer. The noise image Iₙₒᵢₛₑ or the malicious image I_{dep} is input into the first convolutional layer, the first BatchNorm layer, and the first ReLU activation function of the decoder in sequence to acquire image feature N₁. The image feature N₁ is input into the first atrous convolutional layer, the second ReLU activation function, and the first Dropout layer of the decoder in sequence to acquire image feature N₂. The image feature N₂ is input into the first convolutional layer, the first BatchNorm layer, and the first ReLU activation function in the first branch of the first CPC module in sequence to acquire image feature N_{2_1}. The image feature N_{2_1} is input into the second convolutional layer, the second BatchNorm layer, and the second ReLU activation function in the first branch of the first CPC module in sequence to acquire image feature N_{2_2}. The image feature N_{2_2} is input into the third convolutional layer, the third BatchNorm layer, and the third ReLU activation function in the first branch of the first CPC module in sequence to acquire image feature N_{2_3}. The image feature N₂ is input into the second branch of the first CPC module to acquire image feature N₃. The image feature N₃ and the image feature N_{2_3} are subjected to element-wise multiplication to acquire image feature N₄. The image feature N₄ and the image feature N₂ are subjected to corresponding-elements addition to acquire image feature N₅. The image feature N₅ is input into the first convolutional layer, the first BatchNorm layer, and the first ReLU activation function in the first branch of the second CPC module in sequence to acquire image feature N_{5_1}. The image feature N_{5_1} is input into the second convolutional layer, the second BatchNorm layer, and the second ReLU activation function in the first branch of the second CPC module in sequence to acquire image feature N_{5_2}. The image feature N_{5_2} is input into the third convolutional layer, the third BatchNorm layer, and the third ReLU activation function in the first branch of the second CPC module in sequence to acquire image feature N_{5_3}. The image feature N₅ is input into the second branch of the second CPC module to acquire image feature N₆. The image feature N₆ and the image feature N_{5_3} are subjected to element-wise multiplication to acquire image feature N₇. The image feature N₇ and the image feature N₅ are subjected to corresponding-elements addition to acquire image feature N₈. The image feature N₈ is input into the first convolutional layer, the first BatchNorm layer, and the first ReLU activation function in the first branch of the third CPC module in sequence to acquire image feature N_{8_1}. The image feature N_{8_1} is input into the second convolutional layer, the second BatchNorm layer, and the second ReLU activation function in the first branch of the third CPC module in sequence to acquire image feature N_{8_2}. The image feature N_{8_2} is input into the third convolutional layer, the third BatchNorm layer, and the third ReLU activation function in the first branch of the third CPC module in sequence to acquire image feature N_{8_3}. The image feature N₈ is input into the second branch of the third CPC module to acquire image feature N₉. The image feature N₉ and the image feature N_{8_3} are subjected to element-wise multiplication to acquire image feature N₁₀. The image feature N₁₀ and the image feature N₈ are subjected to corresponding-elements addition to acquire image feature N₁₁. The image feature N₁₁ is input into the second convolutional layer, the second BatchNorm layer, and the third ReLU activation function of the decoder in sequence to acquire image feature N₁₂. The image feature N₁₂ is input into the second atrous convolutional layer, the fourth ReLU activation function, and the second Dropout layer of the decoder in sequence to acquire image feature N₁₃. The image feature N₁₃ is input into the flatten layer of the decoder to acquire image feature N₁₄. The image feature N₁₄ is input into the fully connected layer of the decoder to acquire the final watermark Wₘ₁.

In this embodiment, preferably, in the step e-1), the first convolutional layer of the decoder includes 64 channels and a convolutional kernel, with a size of 3, a stride of 1, and a padding of 1. The first atrous convolutional layer of the decoder includes 64 channels and a convolutional kernel, with a size of 3, a dilation rate of 2, a stride of 1, and a padding of 1. The second convolutional layer of the decoder includes 64 channels and a convolutional kernel, with a size of 3, a stride of 1, and a padding of 1. The second atrous convolutional layer of the decoder includes 64 channels and a convolutional kernel, with a size of 3, a dilation rate of 2, a stride of 1, and a padding of 1. The flatten layer and the fully connected layer of the decoder each include 256 neurons.

In an embodiment of the present disclosure, the step f) is as follows.

f-1) Constant count1 is defined with an initial value of 0. It is determined whether the binary values at corresponding positions of the final watermark Wₘ₁ and the watermark Wₘ are the same. If the binary values of the final watermark Wₘ₁ and the watermark Wₘ are different in one bit, it indicates that the binary values at corresponding positions of the final watermark Wₘ₁ and the watermark Wₘ are different. At this point, the constant count1 is incremented by 1, and a final value of the constant count1 is divided by 256 to acquire bit error rate E_{bit}.

f-2) If the bit error rate E_{bit} is less than 0.5, it indicates that the final watermark Wₘ₁ is the watermark Wₘ of the i-th facial image I_{cover_i}, and the face in the i-th facial image I_{cover_i} does not change, achieving a traceability function. Therefore, the noise image Iₙₒᵢₛₑ is a real image. If the bit error rate E_{bit} is greater than or equal to 0.5, the noise image Iₙₒᵢₛₑ is a fake image.

f-3) The malicious image I_{dep} includes a trace of manipulation. Therefore, the i-th facial image I_{cover_i} in the step b) is replaced with the malicious image I_{dep}, and the step b) is repeated to acquire watermark W′ₘ.

f-4) Constant count2 is defined with an initial value of 0. It is determined whether binary values at corresponding positions of the watermark W′ₘ and the watermark Wₘ are the same. If the binary values of the watermark W′ₘ and the watermark Wₘ are different in one bit, the constant count2 is incremented by 1, and a final value of the constant count2 is divided by 256 to acquire bit error rate E′_{bit}.

f-5) It is determined that the malicious image I_{dep} is a real image if the bit error rate E′_{bit} is less than or equal to 0.5. It is determined that the malicious image I_{dep} is a fake image if the bit error rate E′_{bit}, is greater than 0.5. Since the watermark in the malicious image I_{dep} can be robustly recovered from the decoder, the trustworthy original image with the watermark Wₘ can be tracked through matching between facial landmarks and the watermark.

The quantitative comparison results of the bitwise restoration accuracy of watermarks after a common image processing operation and a malicious face swapping operation on the CelebA-HQ dataset at 256×256 resolution are shown in Table 1. The robustness of watermarks is measured based on the accuracy of watermark restoration. The method proposed by the present disclosure achieves an average accuracy of 98.95% in the common image processing operation, which is superior to the state-of-the-art methods. The average accuracy of the method proposed by the present disclosure is improved by 14.29% compared to MBRS and 18.56% compared to FaceSigns. The generalization ability of different face swapping algorithms is evaluated. The method proposed by the present disclosure restores watermarks with an average accuracy of 98.05%, which is improved by 47.82% compared to MBRS and 47.94% compared to FaceSigns.

Finally, it should be noted that the above descriptions are only preferred embodiments of the present disclosure, and are not intended to limit the present disclosure. Although the present disclosure has been described in detail with reference to the foregoing embodiments, those skilled in the art may still modify the technical solutions described in the foregoing embodiments, or equivalently substitute some technical features thereof. Any modification, equivalent substitution, improvement, etc. within the spirit and principles of the present disclosure shall fall within the scope of protection of the present disclosure.

What is claimed is:

1. An active-defense detection method based on a facial landmark watermarking, comprising the following steps:
a) acquiring n facial images to form a facial image set I, I={I₁, I₂, . . . , Iᵢ, . . . , Iₙ}, wherein Iᵢ denotes an i-th facial image, i ∈ {1, . . . ,n}; and preprocessing the i-th facial image Iᵢ, i ε {1, . . . ,n}, to acquire a preprocessed i-th facial image I_{cover_i}, wherein a preprocessed facial image set I_{cover} is acquired;
b) extracting facial landmarks from the preprocessed i-th facial image I_{cover_i}, and converting the facial landmarks into a watermark Wₘ;
c) constructing an encoder, and inputting the i-th facial image I_{cover_i} and the watermark Wₘ into the encoder to acquire a watermark image I_{wm};
d) injecting the watermark image I_{wm} into a noise pool to acquire a noise image Iₙₒᵢₛₑ, and injecting the watermark image I_{wm} into a malicious pool to acquire a malicious image I_{dep};
e) constructing a decoder, and inputting the noise image Iₙₒᵢₛₑ or the malicious image I_{dep} into the decoder to acquire a final watermark Wₘ₁; and
f) determining whether the noise image Iₙₒᵢₛₑ and the malicious image I_{dep} are real or fake images based on the final watermark Wₘ₁.

2. The active-defense detection method based on the facial landmark watermarking according to claim 1, wherein the step a) comprises:
a-1) acquiring the n facial images from a CelebA-HQ dataset to form the facial image set I; and
a-2) resizing, by a resize( ) function in a Python imaging library (PIL), the i-th facial image Iᵢ into a 256×256 image, wherein the preprocessed i-th facial image I_{cover_i} and the preprocessed facial image set I_{cover}={I_{cover_1}, I_{cover_2}, . . . , I_{cover_i}, . . . , I_{cover_n}} are acquired.

3. The active-defense detection method based on the facial landmark watermarking according to claim 1, wherein the step b) comprises:
b-1) detecting, by a Dlib facial landmark detection algorithm, the facial landmarks in the preprocessed i-th facial image I_{cover_i} to acquire a facial landmark set Lₘ comprising m facial landmarks, Lₘ={l₁,l₂, . . . ,lₘ}, m=68, wherein {l₁, l₂, . . . ,l₁₇} are landmarks of a jawline, {l₁₈,l₁₉, . . . ,l₂₂} are landmarks of a right eyebrow, {l₂₃, l₂₄, . . . ,l₂₇} are landmarks of a left eyebrow, {l₂₈, l₂₉, . . . ,l₃₆} are landmarks of a nose, {l₃₇, l₃₈, . . . ,l₄₂} are landmarks of a right eye, {l₄₃, l₄₄, . . . , l₄₈} are landmarks of a left eye, and {l₄₉,l₅₀, . . . , l₆₈} are landmarks of a mouth; and
b-2) defining an i-th landmark lᵢ by a horizontal coordinate xᵢ and a vertical coordinate yᵢ; mapping a value of the horizontal coordinate xᵢ to an integer range of 0-15 through a linear transformation, and converting, by a bin( ) function in Python, the value of the horizontal coordinate xᵢ that is mapped to the integer range of 0-15 into a binary representation Wₓ_{ᵢ} with a length of 4; mapping a value of the vertical coordinate yᵢ to the integer range of 0-15 through the linear transformation, and converting, by the bin( ) function in Python, the value of the vertical coordinate yᵢ that is mapped to the integer range of 0-15 into a binary representation W_{y}i with the length of 4; splicing the binary representation Wₓ_{ᵢ} and the binary representation W_{y}_{ᵢ} into a binary representation W_{xy}_{₋ᵢ} with a length of 8; splicing binary representations of the 68 facial landmarks together into a binary representation W₆₈ with a length of 544; and compressing, by a principal component analysis (PCA)-based dimensionality reduction method, the binary representation W₆₈ to a binary representation with a length of 256 as the watermark Wm.

4. The active-defense detection method based on the facial landmark watermarking according to claim 1, wherein the step c) comprises:
c-1) constructing the encoder, comprising an original image processing unit, a watermark processing unit, a first convolutional layer, a batch normalization (BatchNorm) layer, an activation function layer, and a second convolutional layer;
c-2) constructing the original image processing unit of the encoder, comprising a convolutional layer, a BatchNorm layer, a first rectified linear unit (ReLU) activation function, an atrous convolutional layer, a second ReLU activation function, a Dropout layer, a first combined pooling and convolution (CPC) module, a second CPC module, and a third CPC module; inputting the i-th facial image I_{cover_i} into the convolutional layer, the BatchNorm layer, and the first ReLU activation function of the original image processing unit in sequence to acquire an image feature F_{cover_1}; and inputting the image feature F_{cover_1} into the atrous convolutional layer, the second ReLU activation function, and the Dropout layer of the original image processing unit in sequence to acquire an image feature F_{cover_2};
c-3) constructing the first CPC module, the second CPC module, and the third CPC module, each comprising a first branch and a second branch, wherein the first branch comprises a first convolutional layer, a first BatchNorm layer, a first ReLU activation function, a second convolutional layer, a second BatchNorm layer, a second ReLU activation function, a third convolutional layer, a third BatchNorm layer, and a third ReLU activation function in sequence, while the second branch comprises an average pooling layer, a first convolutional layer, a ReLU activation function, and a second convolutional layer in sequence; inputting the image feature F_{cover_2} into the first convolutional layer, the first BatchNorm layer, and the first ReLU activation function in the first branch of the first CPC module in sequence to acquire an image feature F_{cover_2_1}; inputting the image feature F_{cover_2_1} into the second convolutional layer, the second BatchNorm layer, and the second ReLU activation function in the first branch of the first CPC module in sequence to acquire an image feature F_{cover_2_2}; inputting the image feature F_{cover_2_2} into the third convolutional layer, the third BatchNorm layer, and the third ReLU activation function in the first branch of the first CPC module in sequence to acquire an image feature F_{cover_2_3}; inputting the image feature F_{cover_2} into the second branch of the first CPC module to acquire an image feature F_{cover_3}; subjecting the image feature F_{cover_3} and the image feature F_{cover_2_3} to element-wise multiplication to acquire an image feature F_{cover_4}; subjecting the image feature F_{cover_4} and the image feature F_{cover_2} to corresponding-elements addition to acquire an image feature F_{cover_5}; inputting the image feature F_{cover_5} into the first convolutional layer, the first BatchNorm layer, and the first ReLU activation function in the first branch of the second CPC module in sequence to acquire an image feature F_{cover_5_1}; inputting the image feature F_{cover_5_1} into the second convolutional layer, the second BatchNorm layer, and the second ReLU activation function in the first branch of the second CPC module in sequence to acquire an image feature F_{cover_5_2}; inputting the image feature F_{cover_5_2} into the third convolutional layer, the third BatchNorm layer, and the third ReLU activation function in the first branch of the second CPC module in sequence to acquire an image feature F_{cover_5}; inputting the image feature F_{cover_5} into the second branch of the second CPC module to acquire an image feature F_{cover_6}; subjecting the image feature F_{cover_6} and the image feature F_{cover_5_3} to the element-wise multiplication to acquire an image feature F_{cover_7}; subjecting the image feature F_{cover_7} and the image feature F_{cover_5} to the corresponding-elements addition to acquire an image feature F_{cover_8}; inputting the image feature F_{cover_8} into the first convolutional layer, the first BatchNorm layer, and the first ReLU activation function in the first branch of the third CPC module in sequence to acquire an image feature F_{cover_8_1}; inputting the image feature F_{cover_8_1} into the second convolutional layer, the second BatchNorm layer, and the second ReLU activation function in the first branch of the third CPC module in sequence to acquire an image feature F_{cover_8_2}; inputting the image feature F_{cover_8_2} into the third convolutional layer, the third BatchNorm layer, and the third ReLU activation function in the first branch of the third CPC module in sequence to acquire an image feature F_{cover_8_3}; inputting the image feature F_{cover_8} into the second branch of the third CPC module to acquire an image feature F_{cover_9}; subjecting the image feature F_{cover_9} and the image feature F_{cover_8_3} to the element-wise multiplication to acquire an image feature F_{cover_10}; and subjecting the image feature F_{cover_10} and the image feature F_{cover_8} to the corresponding-elements addition to acquire an image feature F_{cover_11};
c-4) constructing the watermark processing unit of the encoder, comprising a linear layer, a convolutional layer, a first BatchNorm layer, a first ReLU activation function, an atrous convolutional layer, a second ReLU activation function, a first Dropout layer, a first deconvolutional layer, a second BatchNorm layer, a third ReLU activation function, a second deconvolutional layer, a fourth ReLU activation function, a second Dropout layer, a first CPC module, a second CPC module, and a third CPC module; inputting the watermark Wₘ into the linear layer of the watermark processing unit to acquire a watermark feature f₁; inputting the watermark feature f₁ into the convolutional layer, the first BatchNorm layer, and the first ReLU activation function of the watermark processing unit in sequence to acquire a watermark feature f₂; inputting the watermark feature f₂ into the atrous convolutional layer, the second ReLU activation function, and the first Dropout layer of the watermark processing unit in sequence to acquire a watermark feature f₃; inputting the watermark feature f₃ into the first deconvolutional layer, the second BatchNorm layer, and the third ReLU activation function of the watermark processing unit in sequence to acquire a watermark feature f₄; inputting the watermark feature f₄ into the second deconvolutional layer, the fourth ReLU activation function, and the second Dropout layer of the watermark processing unit in sequence to acquire a watermark feature f₅; inputting the watermark feature f₅ into the first convolutional layer, the first BatchNorm layer, and the first ReLU activation function in the first branch of the first CPC module in sequence to acquire a watermark feature f_{m_5_1}; inputting the watermark feature f_{m_5_1} into the second convolutional layer, the second BatchNorm layer, and the second ReLU activation function in the first branch of the first CPC module in sequence to acquire a watermark feature f_{m_5_2}; inputting the watermark feature f_{m_5_2} into the third convolutional layer, the third BatchNorm layer, and the third ReLU activation function in the first branch of the first CPC module in sequence to acquire a watermark feature f_{m_5_3}; inputting the watermark feature f₅ into the second branch of the first CPC module to acquire a watermark feature f_{m_6}; subjecting the watermark feature f_{m_6} and the watermark feature f_{m_5_3} to the element-wise multiplication to acquire a watermark feature f_{m_7}; subjecting the watermark feature f_{m_7} and the watermark feature f₅ to the corresponding-elements addition to acquire a watermark feature f_{m_8}; inputting the watermark feature f_{m_8} into the first convolutional layer, the first BatchNorm layer, and the first ReLU activation function in the first branch of the second CPC module in sequence to acquire a watermark feature f_{m_8_1}; inputting the watermark feature f_{m_8_1} into the second convolutional layer, the second BatchNorm layer, and the second ReLU activation function in the first branch of the second CPC module in sequence to acquire a watermark feature f_{m_8_2}; inputting the watermark feature f_{m_8_2} into the third convolutional layer, the third BatchNorm layer, and the third ReLU activation function in the first branch of the second CPC module in sequence to acquire a watermark feature f_{m_8_3}; inputting the watermark feature f_{m_8} into the second branch of the second CPC module to acquire a watermark feature f_{m_9}; subjecting the watermark feature f_{m_9} and the watermark feature f_{m_8_3} to the element-wise multiplication to acquire a watermark feature f_{m_10}; subjecting the watermark feature f_{m_10} and the watermark feature f_{m_8} to the corresponding-elements addition to acquire a watermark feature f_{m_11}; inputting the watermark feature f_{m_11} into the first convolutional layer, the first BatchNorm layer, and the first ReLU activation function in the first branch of the third CPC module in sequence to acquire a watermark feature f_{m_11_1}; inputting the watermark feature f_{m_11_1} into the second convolutional layer, the second BatchNorm layer, and the second ReLU activation function in the first branch of the third CPC module in sequence to acquire a watermark feature f_{m_11_2}; inputting the watermark feature f_{m_11_2} into the third convolutional layer, the third BatchNorm layer, and the third ReLU activation function in the first branch of the third CPC module in sequence to acquire a watermark feature f_{m_11_3}; inputting the watermark feature f_{m_11} into the second branch of the third CPC module to acquire a watermark feature f_{m_12}; subjecting the watermark feature f_{m_12} and the watermark feature f_{m_11_3} to the element-wise multiplication to acquire a watermark feature f_{m_13}; and subjecting the watermark feature f_{m_13} and the watermark feature f_{m_11} to the corresponding-elements addition to acquire a watermark feature f₆; and
c-5) subjecting the image feature F_{cover_11} and the watermark feature f₆ to the corresponding-elements addition to acquire a feature F₁; inputting the feature F₁ into the first convolutional layer, the BatchNorm layer, and the activation function layer of the encoder in sequence to acquire a feature F₂; and inputting the feature F₂ into the second convolutional layer of the encoder to acquire the watermark image I_{wm}.

5. The active-defense detection method based on the facial landmark watermarking according to claim 4, wherein
in the step c-2), the convolutional layer of the original image processing unit comprises 64 channels and a convolutional kernel, with a size of 3, a stride of 1, and a padding of 1; and the atrous convolutional layer of the original image processing unit comprises 64 channels and a convolutional kernel, with a size of 3, a dilation rate of 2, a stride of 1, and a padding of 1;
in the step c-3), the first convolutional layer, the second convolutional layer, and the third convolutional layer in the first branch each comprise 64 channels and a convolutional kernel, with a size of 3, a stride of 1, and a padding of 1; the first convolutional layer and the second convolutional layer in the second branch each comprise 64 channels and a convolutional kernel, with a size of 3, a stride of 1, and a padding of 1; and the average pooling layer in the second branch has a window size of 4;
in the step c-4), the linear layer of the watermark processing unit comprises 256 input nodes and 256 output nodes; the convolutional layer of the watermark processing unit comprises 64 channels and a convolutional kernel, with a size of 3, a stride of 1, and a padding of 1; the atrous convolutional layer of the watermark processing unit comprises 64 channels and a convolutional kernel, with a size of 3, a dilation rate of 2, a stride of 1, and a padding of 1; and the first deconvolutional layer and the second deconvolutional layer of the watermark processing unit each comprise 64 channels and a convolutional kernel, with a size of 3, a stride of 1, and a padding of 1; and
in the step c-5), the first convolutional layer of the encoder comprises 64 channels and a convolutional kernel, with a size of 3, a stride of 1, and a padding of 1; and the second convolutional layer of the encoder comprises 3 channels and a convolutional kernel, with a size of 1, a stride of 1, and a padding of 1.

6. The active-defense detection method based on the facial landmark watermarking according to claim 1, wherein the step d) comprises:
d-1) constructing the noise pool, comprising Identity noise, Dropout noise, Crop noise, GaussianNoise noise, SaltPepper noise, GaussianBlur noise, MedBlur noise, and joint photographic experts group (JPEG) noise; injecting the watermark image I_{wm} into the noise pool; and adding a noise randomly selected from the noise pool to the watermark image I_{wm} to form the noise image Iₙₒᵢₛₑ; and
d-2) constructing the malicious pool, comprising a simple swapping (SimSwap) model, an information bottleneck disentanglement for identity swapping (InfoSwap) model, a unified cross-entropy loss for deep face recognition (UniFace) model, and attribute manipulation algorithms; injecting the watermark image I_{wm} into the malicious pool; and manipulating, by a model or attribute manipulation algorithm randomly selected from the malicious pool, the watermark image I_{wm} to form the malicious image I_{dep}.

7. The active-defense detection method based on the facial landmark watermarking according to claim 4, wherein the step e) comprises:
e-1) constructing the decoder, comprising a first convolutional layer, a first BatchNorm layer, a first ReLU activation function, a first atrous convolutional layer, a second ReLU activation function, a first Dropout layer, a first CPC module, a second CPC module, a third CPC module, a second convolutional layer, a second BatchNorm layer, a third ReLU activation function, a second atrous convolutional layer, a fourth ReLU activation function, a second Dropout layer, a flatten layer, and a fully connected layer;
inputting the noise image Iₙₒᵢₛₑ or the malicious image I_{dep} into the first convolutional layer, the first BatchNorm layer, and the first ReLU activation function of the decoder in sequence to acquire an image feature N₁;
inputting the image feature N₁ into the first atrous convolutional layer, the second ReLU activation function, and the first Dropout layer of the decoder in sequence to acquire an image feature N₂;
inputting the image feature N₂ into the first convolutional layer, the first BatchNorm layer, and the first ReLU activation function in the first branch of the first CPC module in sequence to acquire an image feature N_{2_1};
inputting the image feature N_{2_1} into the second convolutional layer, the second BatchNorm layer, and the second ReLU activation function in the first branch of the first CPC module in sequence to acquire an image feature N_{2_2};
inputting the image feature N_{2_2} into the third convolutional layer, the third BatchNorm layer, and the third ReLU activation function in the first branch of the first CPC module in sequence to acquire an image feature N_{2_3};
inputting the image feature N₂ into the second branch of the first CPC module to acquire an image feature N₃;
subjecting the image feature N₃ and the image feature N_{2_3} to the element-wise multiplication to acquire an image feature N₄;
subjecting the image feature N₄ and the image feature N₂ to the corresponding-elements addition to acquire an image feature N₅;
inputting the image feature N₅ into the first convolutional layer, the first BatchNorm layer, and the first ReLU activation function in the first branch of the second CPC module in sequence to acquire an image feature N_{5_1};
inputting the image feature N_{5_1} into the second convolutional layer, the second BatchNorm layer, and the second ReLU activation function in the first branch of the second CPC module in sequence to acquire an image feature N_{5_2};
inputting the image feature N_{5_2} into the third convolutional layer, the third BatchNorm layer, and the third ReLU activation function in the first branch of the second CPC module in sequence to acquire an image feature N_{5_3};
inputting the image feature N₅ into the second branch of the second CPC module to acquire an image feature N₆;
subjecting the image feature N₆ and the image feature N_{5_3} to the element-wise multiplication to acquire an image feature N₇;
subjecting the image feature N₇ and the image feature N₅ to the corresponding-elements addition to acquire an image feature N₈;
inputting the image feature N₈ into the first convolutional layer, the first BatchNorm layer, and the first ReLU activation function in the first branch of the third CPC module in sequence to acquire an image feature N_{8_1};
inputting the image feature N_{8_1} into the second convolutional layer, the second BatchNorm layer, and the second ReLU activation function in the first branch of the third CPC module in sequence to acquire an image feature N_{8_2};
inputting the image feature N_{8_2} into the third convolutional layer, the third BatchNorm layer, and the third ReLU activation function in the first branch of the third CPC module in sequence to acquire an image feature N_{8_3};
inputting the image feature N₈ into the second branch of the third CPC module to acquire an image feature N₉;
subjecting the image feature N₉ and the image feature N_{8_3} to the element-wise multiplication to acquire an image feature N₁₀;
subjecting the image feature N₁₀ and the image feature N₈ to the corresponding-elements addition to acquire an image feature N₁₁;
inputting the image feature N₁₁ into the second convolutional layer, the second BatchNorm layer, and the third ReLU activation function of the decoder in sequence to acquire an image feature N₁₂;
inputting the image feature N₁₂ into the second atrous convolutional layer, the fourth ReLU activation function, and the second Dropout layer of the decoder in sequence to acquire an image feature N₁₃;
inputting the image feature N₁₃ into the flatten layer of the decoder to acquire an image feature N₄; and
inputting the image feature N₁₄ into the fully connected layer of the decoder to acquire the final watermark Wₘ₁.

8. The active-defense detection method based on the facial landmark watermarking according to claim 7, wherein in the step e-1),
the first convolutional layer of the decoder comprises 64 channels and a convolutional kernel, with a size of 3, a stride of 1, and a padding of 1;
the first atrous convolutional layer of the decoder comprises 64 channels and a convolutional kernel, with a size of 3, a dilation rate of 2, a stride of 1, and a padding of 1;
the second convolutional layer of the decoder comprises 64 channels and a convolutional kernel, with a size of 3, a stride of 1, and a padding of 1;
the second atrous convolutional layer of the decoder comprises 64 channels and a convolutional kernel, with a size of 3, a dilation rate of 2, a stride of 1, and a padding of 1; and
the flatten layer and the fully connected layer of the decoder each comprise 256 neurons.

9. The active-defense detection method based on the facial landmark watermarking according to claim 1, wherein the step f) comprises:
f-1) defining a constant count1 with an initial value of 0; determining whether binary values at corresponding positions of the final watermark Wₘ₁ and the watermark Wₘ are the same; and when the binary values of the final watermark Wₘ₁ and the watermark Wₘ are different in one bit: incrementing the constant count1 by 1, and dividing a final value of the constant count1 by 256 to acquire a bit error rate E_{bit};
f-2) determining that the noise image Iₙₒᵢₛₑ is a real image when the bit error rate E_{bit} is less than 0.5; and determining that the noise image Iₙₒᵢₛₑ is a fake image when the bit error rate E_{bit} is greater than or equal to 0.5;
f-3) replacing the i-th facial image I_{cover_i} in the step b) with the malicious image I_{dep}, and repeating the step b) to acquire a watermark W′ₘ;
f-4) defining a constant count2 with an initial value of 0; determining whether binary values at corresponding positions of the watermark W′ₘ and the watermark Wₘ are the same; and when the binary values of the watermark W′ₘ and the watermark Wₘ are different in one bit: incrementing the constant count2 by 1, and dividing a final value of the constant count2 by 256 to acquire a bit error rate E′_{bit}; and
f-5) determining that the malicious image I_{dep} is a real image when the bit error rate E′_{bit} is less than or equal to 0.5; and determining that the malicious image I_{dep} is a fake image when the bit error rate E′_{bit}, is greater than 0.5.
